(19) United States
(12) Patent Application Publication
(10) Pub. No.: US 2007/0206844 A1
(43) Pub. Date: Sep. 6, 2007

(54) Method and apparatus for breast border detection

(75) Inventors: Daniel Russakoff, Mountain View, CA (US); Akira Hasegawa, Saratoga, CA (US)

Correspondence Address: BIRCH STEWART KOLASCH & BIRCH, PO BOX 747, FALLS CHURCH, VA, 22040-0747, US

(73) Assignee: FUJI PHOTO FILM CO., LTD.

(21) Appl. No.: 11/366,495

(22) Filed: Mar. 3, 2006

(51) Int. Cl. G06K 9/00; G06K 9/62

(52) U.S. Cl. 382/132; 382/225

(57) ABSTRACT

A method and an apparatus process images. The method according to one embodiment accesses digital image data representing an image including a breast; clusters pixels of the image to obtain initial clusters, based on a parameter relating to a spatial characteristic of the pixels in the image, a parameter relating to an intensity characteristic of the pixels in the image, and a parameter relating to a smoothness characteristic of the pixels in the image; and detects a breast cluster, the step of detecting a breast cluster including performing cluster merging for the initial clusters using an intensity measure of the initial clusters to obtain final clusters, and eliminating from the final clusters pixels that do not belong to the breast, to obtain a breast cluster.

### BACKGROUND OF THE INVENTION

1. Field of the Invention

The present invention relates to a digital image processing technique, and more particularly to a method and apparatus for processing breast images and detecting breast borders in a mammography image.

2. Description of the Related Art

Mammography images are powerful tools used in diagnosis of medical problems of breasts. An important feature in mammography images is the breast shape. A clear image of the breast shape is directly dependent on a correct identification of breast borders. Clearly detected breast borders can be used to identify breast abnormalities, such as skin retraction and skin thickening, which are characteristics of malignancy. Clear breast borders also facilitate automatic or manual comparative analysis between mammography images. Breast borders may convey significant information relating to breast deformation, size, and shape evolution. The position of the nipple with respect to the breast can be used to detect breast abnormalities. Unclear breast borders on the other hand, may obscure abnormal breast growth and deformation. Mammography images with unclear breast borders pose challenges when used in software applications that process and compare images.

Due to the way the mammogram acquisition process works, the region where the breast tapers off has decreased breast contour contrast, which makes breast borders unclear. Algorithms for border detection are typically used to extract breast borders. Breast borders, also referred to as the skin-air interface, or the breast boundary, can be obtained by edge-detection techniques, or by methods than determine a breast region in a mammography image. Non-uniform background regions, tags, labels, or scratches present in mammography images may obscure the breast border area and create problems for breast border detection algorithms.

Prior art methods to detect breast borders include edge detection, thresholding, and pixel classification. One such breast border detection technique is described in U.S. Pat. No. 5,572,565, entitled“Automatic Segmentation, Skinline and Nipple Detection in Digital Mammograms”. In the technique described in this work, digital mammograms are automatically segmented into background and foreground, where the foreground corresponds to the breast region. A binary array is created by assigning a binary one value to pixels whose intensity or gradient amplitude, or both exceed certain thresholds. This technique, however, is challenged when non-breast pixels, belonging to a noisy background for example, have similar intensity or gradient values to some breast pixels.

Another breast border detection technique is described in U.S. Pat. No. 5,889,882 entitled“Detection of Skin-Line Transition in Digital Medical Imaging”. In the technique described in this work, the skin-line border in a digital medical image is determined using a threshold to separate the breast from the background. A classifier is then used to specify which pixels are associated with the skin-line border. This method, however, relies on an absolute threshold. Such a threshold can impair the determination of breast borders when pixels above and below threshold are interspersed in the breast mass as well as in the background.

Disclosed embodiments of this application address these and other issues by using a breast border detection method and apparatus that cluster breast pixels using k-means clustering, and do not rely on absolute thresholds or gradients.

### SUMMARY OF THE INVENTION

The present invention is directed to a method and an apparatus for processing images. According to a first aspect of the present invention, an image processing method comprises: accessing digital image data representing an image including a breast; clustering pixels of the image to obtain initial clusters, based on a parameter relating to a spatial characteristic of the pixels in the image, a parameter relating to an intensity characteristic of the pixels in the image, and a parameter relating to a smoothness characteristic of the pixels in the image; and detecting a breast cluster, the step of detecting a breast cluster including performing cluster merging for the initial clusters using an intensity measure of the initial clusters to obtain final clusters, and eliminating from the final clusters pixels that do not belong to the breast, to obtain a breast cluster.

According to a second aspect of the present invention, an apparatus for processing images comprises: an image data input unit for accessing digital image data representing an image including a breast; a clustering unit for clustering pixels of the image to obtain initial clusters, the clustering unit clustering pixels based on a parameter relating to a spatial characteristic of the pixels in the image, a parameter relating to an intensity characteristic of the pixels in the image, and a parameter relating to a smoothness characteristic of the pixels in the image; a cluster merging unit for performing cluster merging for the initial clusters using an intensity measure of the initial clusters to obtain final clusters; and a border detection unit for detecting a breast cluster by eliminating from the final clusters pixels that do not belong to the breast, to obtain a breast cluster.

### BRIEF DESCRIPTION OF THE DRAWINGS

Further aspects and advantages of the present invention will become apparent upon reading the following detailed description in conjunction with the accompanying drawings, in which:

FIG. 1 is a general block diagram of a system including an image processing unit for breast border detection according to an embodiment of the present invention;

FIG. 2 is a block diagram illustrating in more detail aspects of the image processing unit for breast border detection according to an embodiment of the present invention;

FIG. 3 is a block diagram of an exemplary image processing unit for breast border detection according to an embodiment of the present invention illustrated in FIG. 2;

FIG. 4 is a flow diagram illustrating operations performed by an image processing unit for breast border detection according to an embodiment of the present invention illustrated in FIG. 3;

FIG. 5 is a flow diagram illustrating operations performed by a subsampling unit included in an image processing unit for breast border detection according to an embodiment of the present invention illustrated in FIG. 3;

FIG. 6 is a flow diagram illustrating operations performed by a cropping unit included in an image processing unit for breast border detection according to an embodiment of the present invention illustrated in FIG. 3;

FIG. 7A illustrates an exemplary mammogram image with visible imaging plate along two edges;

FIG. 7B illustrates an exemplary mammogram image obtained after imaging plate cropping according to an embodiment of the present invention illustrated in FIG. 6;

FIG. 8 is a flow diagram illustrating operations performed by a clustering unit included in an image processing unit for breast border detection according to an embodiment of the present invention illustrated in FIG. 3;

FIG. 9 illustrates an exemplary output of a clustering unit included in an image processing unit for breast border detection according to an embodiment of the present invention illustrated in FIG. 8;

FIG. 10 is a flow diagram illustrating operations performed by a cluster merging unit included in an image processing unit for breast border detection according to an embodiment of the present invention illustrated in FIG. 3;

FIG. 11 illustrates an exemplary output of a cluster merging unit included in an image processing unit for breast border detection according to an embodiment of the present invention illustrated in FIG. 10;

FIG. 12 is a flow diagram illustrating operations performed by a connected components analysis and selection unit included in an image processing unit for breast border detection according to an embodiment of the present invention illustrated in FIG. 3;

FIG. 13 is a flow diagram illustrating operations performed by a tag rejection unit included in an image processing unit for breast border detection according to an embodiment of the present invention illustrated in FIG. 3;

FIG. 14 illustrates an exemplary output of a tag rejection unit included in an image processing unit for breast border detection according to an embodiment of the present invention illustrated in FIG. 13;

FIG. 15 is a flow diagram illustrating operations performed by a supersampling unit included in an image processing unit for breast border detection according to an embodiment of the present invention illustrated in FIG. 3; and

FIG. 16 illustrates exemplary outputs of an image processing unit for breast border detection according to an embodiment of the present invention illustrated in FIG. 3.

### DETAILED DESCRIPTION

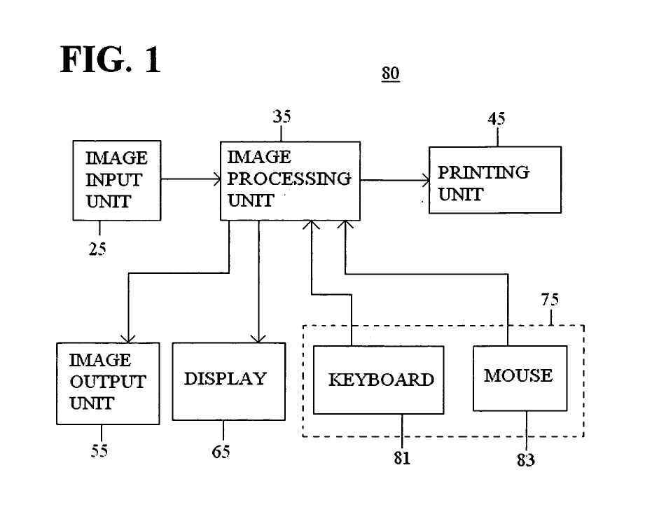

Aspects of the invention are more specifically set forth in the accompanying description with reference to the appended figures. FIG. 1 is a general block diagram of a system including an image processing unit for breast border detection according to an embodiment of the present invention. The system 80 illustrated in FIG. 1 includes the following components: an image input unit 25; an image processing unit 35; a display 65; an image output unit 55; a user input unit 75; and a printing unit 45. Operation of the system 80 in FIG. 1 will become apparent from the following discussion.

The image input unit 25 provides digital image data representing a mammogram. Image input unit 25 may be one or more of any number of devices providing digital image data derived from a radiological film, a diagnostic image, a digital system, etc. Such an input device may be, for example, a scanner for scanning images recorded on a film; a digital camera; a digital mammography machine; a recording medium such as a CD-R, a floppy disk, a USB drive, etc.; a database system which stores images; a network connection; an image processing system that outputs digital data, such as a computer application that processes images; etc.

The image processing unit 35 receives digital image data from the image input unit 25 and performs breast border detection in a manner discussed in detail below. A user, e.g., a radiology specialist at a medical facility, may view the output of image processing unit 35, via display 65 and may input commands to the image processing unit 35 via the user input unit 75. In the embodiment illustrated in FIG.1, the user input unit 75 includes a keyboard 81 and a mouse 83, but other conventional input devices could also be used.

In addition to performing breast border detection in accordance with embodiments of the present invention, the image processing unit 35 may perform additional image processing functions in accordance with commands received from the user input unit 75. The printing unit 45 receives the output of the image processing unit 35 and generates a hard copy of the processed image data. In addition or as an alternative to generating a hard copy of the output of the image processing unit 35, the processed image data may be returned as an image file, e.g., via a portable recording medium or via a network (not shown). The output of image processing unit 35 may also be sent to image output unit 55 that performs further operations on image data for various purposes. The image output unit 55 may be a module that performs further processing of the image data, a database that collects and compares images, etc.

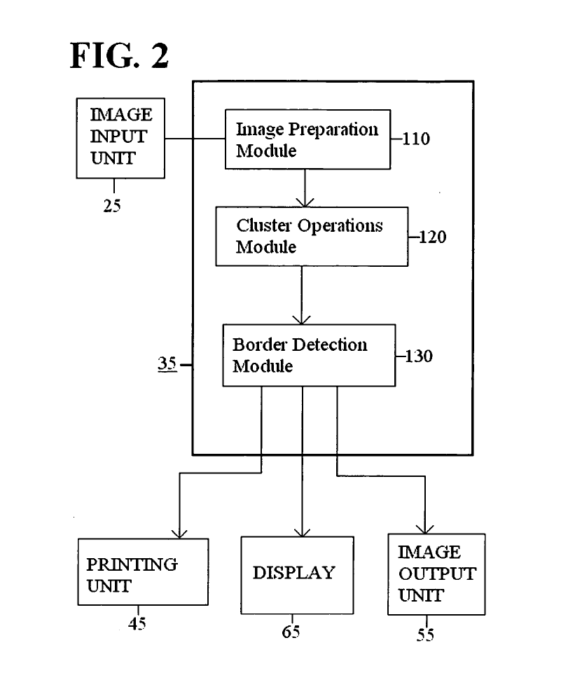

FIG. 2 is a block diagram illustrating in more detail aspects of the image processing unit 35 for breast border detection according to an embodiment of the present invention. As shown in FIG. 2, the image processing unit 35 according to this embodiment includes: an image preparation module 110; a cluster operations module 120; and a border detection module 130. Although the various components of FIG. 2 are illustrated as discrete elements, such an illustration is for ease of explanation and it should be recognized that certain operations of the various components may be performed by the same physical device, e.g., by one or more microprocessors.

Generally, the arrangement of elements for the image processing unit 35 illustrated in FIG. 2 performs preprocessing and preparation of digital image data including a breast image, cluster identification in the breast image, and detection of breast borders in the breast image. Image preparation module 110 receives a breast image from image input unit 25 and may perform preprocessing and preparation operations on the breast image. Preprocessing and preparation operations performed by image preparation module 110 may include resizing, cropping, compression, color correction, etc., that change size and/or appearance of the breast image.

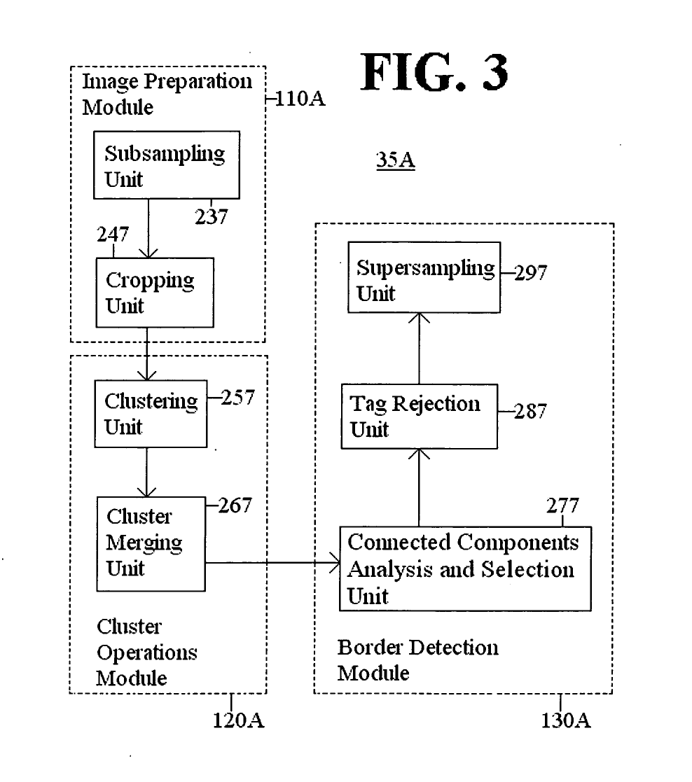

Image preparation module 110 sends the preprocessed breast image to cluster operations module 120, which identifies clusters in the breast image. Border detection module 130 receives an image with identified clusters from cluster operations module 120, and detects breast borders in the image. Finally, border detection module 130 outputs a breast image with identified breast borders. The output of border detection module 130 may be sent to image output unit 55, printing unit 45, and/or display 65. Operation of the components included in the image processing unit 35 illustrated in FIG. 2 will be next described with reference to FIGS. 3-16.

Image preparation module 110, cluster operations module 120, and border detection module 130 are software systems/applications. Image preparation module 110, cluster operations module 120, and border detection module 130 may also be purpose built hardware such as FPGA, ASIC, etc.

FIG. 3 is a block diagram of an exemplary image processing unit 35A for breast border detection according to an embodiment of the present invention illustrated in FIG. 2. As shown in FIG. 3, image processing unit 35A includes: a subsampling unit 237; a cropping unit 247; a clustering unit 257; a cluster merging unit 267; a connected components analysis and selection unit 277; a tag rejection unit 287; and a supersampling unit 297.

Subsampling unit 237 and cropping unit 247 are included in image preparation module 110A. Clustering unit 257 and cluster merging unit 267 are included in cluster operation module 120A. Connected components analysis and selection unit 277, tag rejection unit 287, and supersampling unit 297 are included in border detection module 130A. The arrangement of elements for the image processing unit 35A illustrated in FIG. 3 performs preprocessing and preparation of a breast image, cluster analysis, and elimination of non-breast regions from the breast image. The output of supersampling unit 297 is a breast image with identified breast borders. Such an output image may be sent to image output unit 55, printing unit 45, and/or display 65. Subsampling unit 237, cropping unit 247, clustering unit 257, cluster merging unit 267, connected components analysis and selection unit 277, tag rejection unit 287, and supersampling unit 297 may be implemented using software and/or hardware.

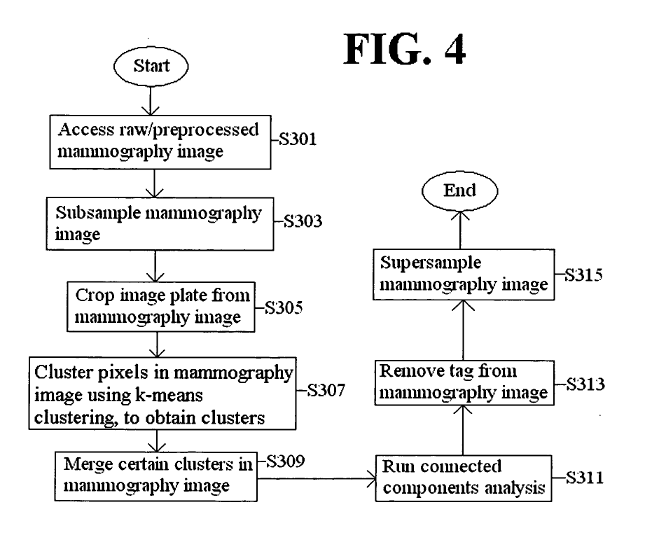

FIG. 4 is a flow diagram illustrating operations performed by an image processing unit 35A for breast border detection according to an embodiment of the present invention illustrated in FIG. 3. Subsampling unit 237 receives (S301) a raw or a preprocessed breast image from image input unit 25, and subsamples (S303) the image to decrease its size. Cropping unit 247 receives the subsampled image and crops (S305) imaging plate artifacts that may be present in the subsampled image. Clustering unit 257 uses k-means clustering to group pixels into clusters (S307) in the cropped breast image. Cluster merging unit 267 merges certain clusters (S309) in the breast image using a cluster intensity test. Connected components analysis and selection unit 277 eliminates some clusters (S311) that are not related to the breast in the image. Tag rejection unit 287 removes image tags (S313) from the breast image, in case such tags have not been removed in previous steps. Finally, supersampling unit 297 supersamples (S315) the mammography image and outputs a breast image that shows the breast borders.

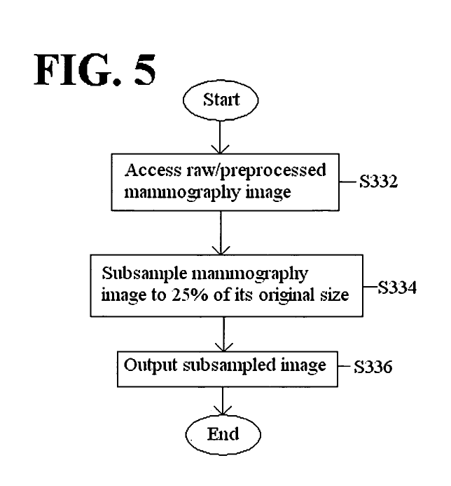

FIG. 5 is a flow diagram illustrating operations performed by a subsampling unit 237 included in an image processing unit 35A for breast border detection according to an embodiment of the present invention illustrated in FIG. 3. Subsampling unit 237 accesses a breast image (S332), subsamples (S334) the image to, for example, 25% of its original size, and outputs (S336) a subsampled image. Subsampling is done for computational convenience and faster processing. Subsampling also has a noise reduction effect on the breast image. Subsampling is an optional step for the embodiments for breast border detection described in this application.

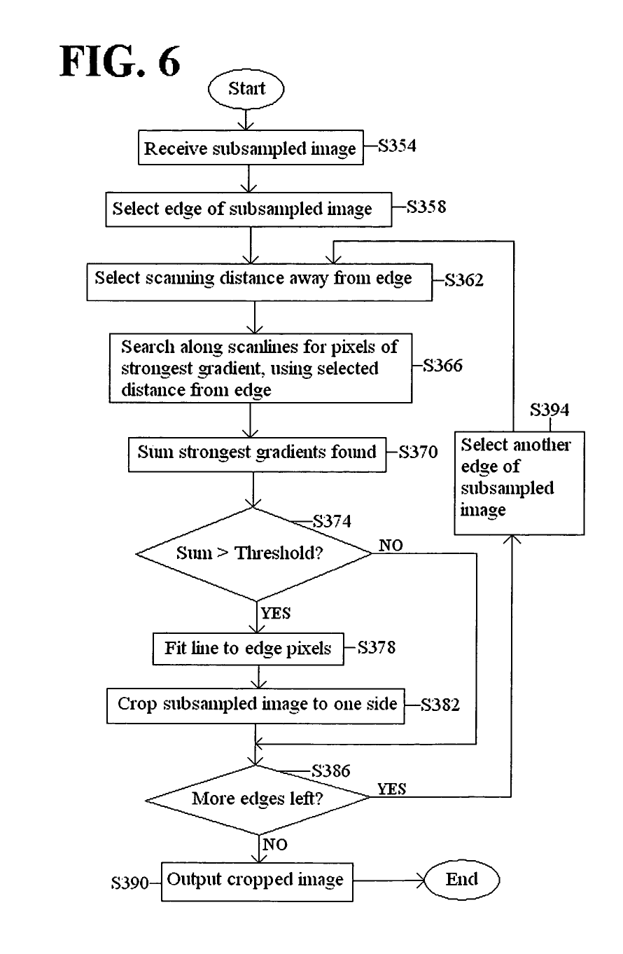

FIG. 6 is a flow diagram illustrating operations performed by a cropping unit 247 included in an image processing unit 35A for breast border detection according to an embodiment of the present invention illustrated in FIG. 3. Cropping unit 247 removes imaging plate artifacts from a subsampled breast image.

Outlines of imaging plates can frequently be seen in mammograms. The pixels from imaging plate artifacts can throw off the typical distributions of pixels in a mammogram, as pixels associated with an imaging plate can be mistaken as breast pixels. Such a case would occur, for example, when imaging plate pixels are connected to the breast and have intensities similar to the breast pixels. Hence, imaging plate pixels can cause problems in breast border detection.

Cropping unit 247 removes imaging plate pixels from a mammogram by looking along the outer edges of the image. Cropping unit 247 receives (S354) a subsampled image from subsampling unit 237. An edge of the subsampled image is selected (S358). A scanning distance for scanning away from the edge is also selected (S362). The scanning distance is calculated based on knowledge of typical physical sizes of imaging plates in mammography images. Cropping unit 247 then searches (S366) along scanlines perpendicular to the selected edge of the subsampled image, for pixels with strongest gradient located within the scanning distance from the edge. The strongest gradients found are summed (S370). The sum of strongest gradients is compared to a threshold (S374).

The thresholds used in the current application are relative thresholds. The difference between a relative threshold and an absolute threshold is reflected in the strength of the assumptions used to derive that threshold. Relative thresholds are based on weaker assumptions than absolute thresholds. A threshold that applies to the pixel values themselves is an absolute threshold. For example, deciding that breast pixels (which are typically bright) have pixel values larger than 200, establishes an absolute threshold. Such an assumption is strong, because it assumes that non-breast pixels have pixel values smaller than 200. There are a number of situations where this strong assumption might not be met, such as when isotropic brightening is applied to all the pixels in an image. On the other hand, a threshold based solely on relative differences between pixel values requires weaker assumptions and is a relative threshold. A relative threshold gives more robust results than an absolute threshold. While an absolute threshold would give misleading results when isotropic brightening is applied to all the pixels in an image, such isotropic lightening of an image would not affect a relative threshold. Similarly, global alterations of the image that affect all pixels in the image in the same way do not pose challenges to relative thresholds.

The threshold used in step S374 is a relative threshold, which is defined based on empirical evidence of mammography images with and without imaging plates. Imaging plates are man-made structures that look very similar across mammography images. As a result, a number of reasonable and non-absolute assumptions can be made about the values of gradients along scanlines perpendicular to the image edges. These assumptions are derived from values of such gradients when imaging plates are present in mammography images, as opposed to the case when imaging plates are not present. From these derived assumptions, the threshold for step S374 is found.

If the sum of strongest gradients is smaller than or equal to the threshold, no imaging plate artifacts are present along the selected edge. A test is then performed (S386) to see if there are more outer edges in the mammography image to be tested for imaging plate artifacts.

If the sum of strongest gradients along the selected edge is larger than the threshold, then an imaging plate outline exists along the selected edge. A line is fit (S378) to the edge pixels with the strongest gradient. The subsampled breast image is then cropped (S382) to one side to remove the imaging plate region present along the edge. A test is performed (S386) to see if there are more outer edges in the mammography image to be tested for imaging plate artifacts. If more outer edges are available for testing, a new edge from among the untested edges is selected (S394). Steps S362, S366, S370, S374, S378 and S382 are repeated for each outer edge in the breast image. When imaging plate artifacts have been cropped and removed from the top, bottom, left and right outer edges of the image, cropping unit 247 outputs (S390) a cropped image. This procedure effectively removes imaging plate artifacts in mammograms.

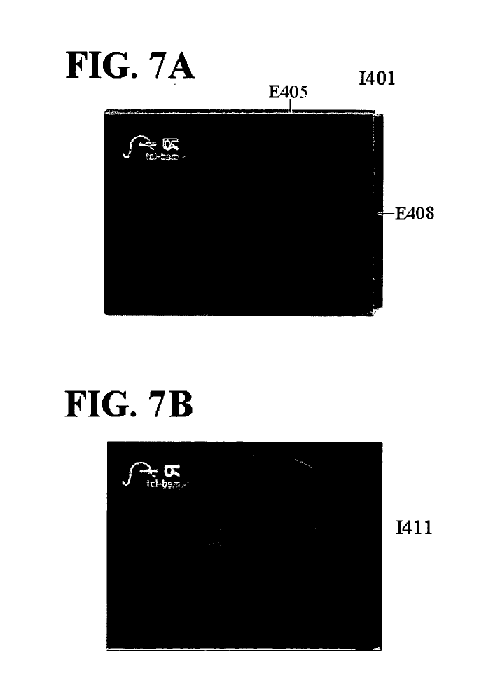

FIG. 7A illustrates an exemplary mammogram image with visible imaging plate along two edges. Imaging plate regions E405 and E408 are visible along the top and right edges of mammography image I401.

FIG. 7B illustrates an exemplary mammogram image obtained after imaging plate cropping according to an embodiment of the present invention illustrated in FIG. 6. The top and right edges of mammogram image 1401 in FIG. 7A were cropped to remove the imaging plate regions E405 and E408. The resulting image 1411 does not exhibit imaging plate artifacts.

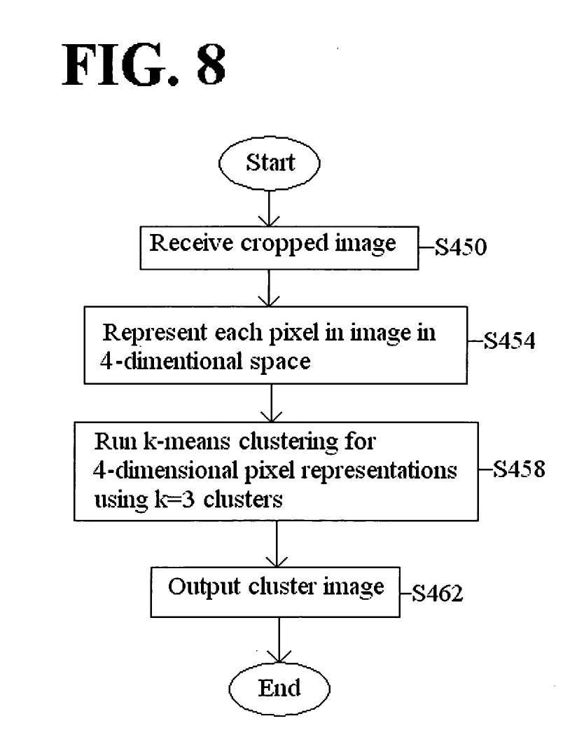

FIG. 8 is a flow diagram illustrating operations performed by a clustering unit 257 included in an image processing unit 35A for breast border detection according to an embodiment of the present invention illustrated in FIG. 3. Clustering unit 257 receives (S450) a cropped image from cropping unit 247, and creates a 4-dimensional pixel representation (S454) for each pixel in the cropped image. The axes in the 4-dimensional pixel space represent the x-location of pixels, the y-locations of pixels, the intensity value of pixels, and the distance of pixels to a reference point. In one embodiment, the reference point is located in the middle of the bottom row of pixels in the cropped image. Each pixel can be thought of as a point in [symbol] ⁴. The first two dimensions in the 4-dimensional [symbol] ⁴ space, namely the x-location and the y-location, enforce a spatial relationship of pixels that belong to the same cluster. Hence, pixels that belong to the same cluster have similar x-location values and similar y-location values in the [symbol] ⁴ space.

The first two dimensions in the 4-dimensional [symbol] ⁴ space may be other spatial coordinates as well. The first two dimensions in the 4-dimensional [symbol] ⁴ space may be, for example, a combination of the x-location and y-location coordinates, or polar or cylindrical coordinates. The third dimension in the 4-dimensional [symbol] ⁴ space, namely the intensity value of pixels, enforces the fact that pixels that belong to the same cluster are typically similar in intensity. Finally, the 4^{th} dimension in the 4-dimensional [symbol] ⁴ space, namely the distance of pixels to the reference point, introduces a smoothness constraint about the reference point. The smoothness constraint relates to the fact that breast shapes are typically smoothly varying about the reference point.

In one implementation, an optional 5^{th} dimension was introduced as the histogram-equalized intensity value of pixels. In that case, a 5-dimensional pixel representation for each pixel in the cropped image is implemented in step S454. The histogram-equalized intensity value dimension also enforces the fact that pixels that belong to the same cluster are typically similar in intensity.

Clustering unit 257 runs (S458) k-means clustering of pixels in the 4-dimensional space using k=3 clusters. This number of clusters was chosen based on the assumption that mammography images typically have 2 main clusters. Of the 2 main clusters, one cluster encompasses bright areas in the mammography image such as the breast area and tag areas, and the other cluster encompasses dark areas, such as background areas. Tag areas include labels incorporated in the breast image that list the view of the mammogram and/or the identity of the person (patient ID) whose breasts are imaged in the mammogram. The Mammography Quality Standards Act of 1992 (MQSA) dictates that the tag should not overlap the breast in a mammography image. Hence, the cluster encompassing bright areas typically includes two connected components, one component for the breast and one component for the tag. While mammography images typically have 2 main clusters, certain abnormal mammograms, such as mammograms of breasts with implants or breasts located close to pacemakers, might include a third cluster. This is why in step S458 the k-means clustering of pixels in the 4-dimensional space is done using k=3 clusters.

The clustering may be initialized using P. Bradley and U. Fayyad's method as described in“Refining Initial Points for K-Means Clustering” from Proceedings of the 15^{th} International Conference of Machine Learning, pp. 91-99, 1998, the entire contents of which are hereby incorporated by reference. The clustering may be initialized using other methods as well. In one implementation, L2 is used as the distance metric for k-means clustering in step S458. K-means clustering divides the group of 4-dimensional pixel representations into clusters such that a distance metric relative to the centroids of the clusters is minimized. 4-dimensional pixel representations are assigned to clusters and then the positions of the cluster centroids are determined. The value of the distance metric to be minimized is also determined. Some of the 4-dimensional pixel representations are then reassigned to different clusters for distance metric minimization. New cluster centroids are determined, and the distance metric to be minimized is calculated again. The reassigning procedure for 4-dimensional pixel representations is continued to refine the clusters, i.e., to minimize the distance metric relative to the centroids of the clusters. Convergence in the k-means clustering method is achieved when no pixel changes its cluster membership. At that point, 3 clusters in the mammography image have been identified, and a cluster image is output (S462).

The cluster image output in step S462 has 3 clusters. For a mammogram that includes implants, the 3 clusters would be distributed in the following manner: one cluster for background pixels; a second cluster for foreground pixels, which include the breast pixels and the tag pixels but not the implant pixels; and a third cluster for the implant pixels. Hence, in the case of an abnormal mammogram with an implant, one cluster represents the background and 2 clusters represent the breast and tag area, and the implant area. A similar situation occurs when the mammography image includes a pacemaker.

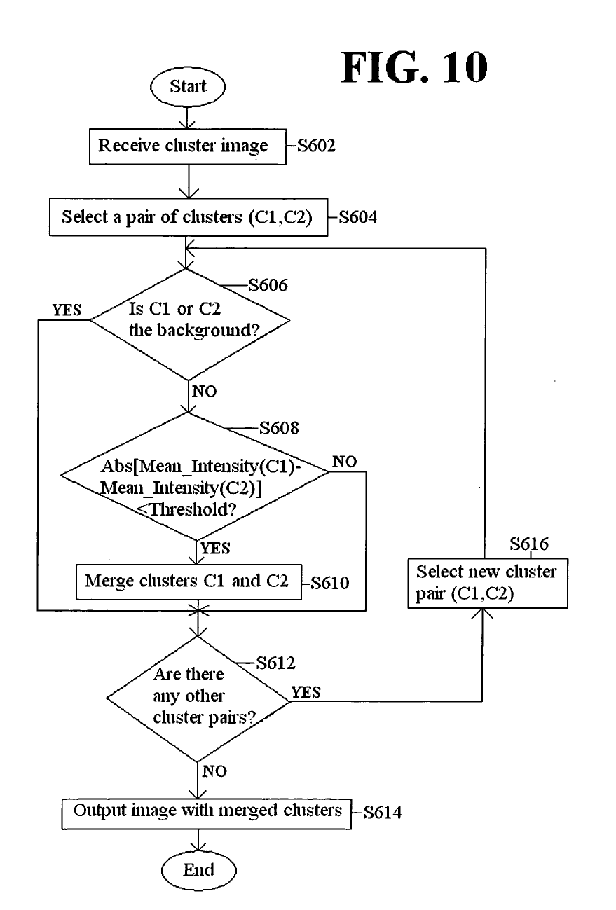

A mammogram that does not include implants or pacemakers typically has 2 main clusters, one cluster corresponding to the background pixels and one cluster corresponding to foreground pixels, which include the breast pixels and the tag pixels. However, the cluster image output in step S462 has 3 clusters, so one of the true clusters (foreground or background cluster) is artificially split. Hence, the extra cluster for a mammography image that does not include implants or pacemakers is one of the artificially split clusters. The cluster artificially split can be either the foreground cluster or the background cluster. The presence of the artificial cluster is detected by the merging mechanism illustrated in FIG. 10.

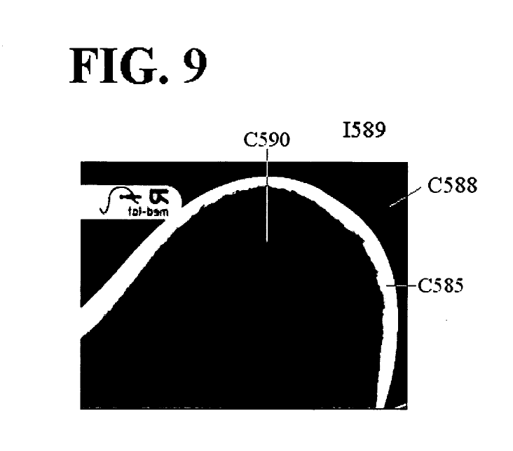

FIG. 9 illustrates an exemplary output of clustering unit 257 included in an image processing unit 35A for breast border detection using according to an embodiment of the present invention illustrated in FIG. 8. FIG. 9 illustrates a cluster image I589 obtained from cropped image I411 in FIG. 7B. Image I589 shows 3 clusters, C590, C588 and C585, obtained through k-means clustering. The clusters were obtained in the 4-dimensional space described in the algorithm of FIG. 8. A 4-dimensional space is difficult to display, so the image in FIG. 9 is a 2-dimensional projection of the 4-dimensional clustering results. The 3 clusters C590, C588 and C585 include white pixels (cluster C585), gray pixels (C590), and black pixels (C588). In FIG. 9, the black pixels represent the background cluster. The color of the background in a mammography image is the integral color of an image that would be obtained from a mammography machine when no breasts are present.

FIG. 10 is a flow diagram illustrating operations performed by a cluster merging unit 267 included in an image processing unit 35A for breast border detection according to an embodiment of the present invention illustrated in FIG. 3.

Cluster merging unit 267 receives a cluster image (S602) in which each pixel is mapped to one of 3 clusters. A mammography image including one breast without abnormal characteristics such as implants, has two main clusters, one corresponding to the breast and tag areas, and one to the background. However, 3 clusters have been identified in the breast image by clustering unit 257, so one of the two main clusters was artificially split into two clusters. The two artificially split clusters can be combined into one cluster by cluster merging unit 267. Cluster merging unit 267 decides whether or not to merge certain clusters. Two clusters are merged if and only if two conditions are met: one of the clusters is not the background (the background being the cluster with the lowest mean intensity value), and the difference between the mean cluster intensities of the two clusters is less than a predetermined threshold. The predetermined threshold is a relative threshold determined empirically using large amounts of mammography images data.

To determine if merging of clusters is to be performed, cluster merging unit 267 selects (S604) a pair of clusters (C1, C2) and tests (S606) if C1 or C2 is the background. The test in step S606 tests if one of clusters C1 or C2 has the lowest mean intensity value among clusters in the cluster image, because the background is darker than the breast and other image artifacts in mammography images. Thus is so because mammograms are measures of X-ray attenuation. X-rays are shot through the breast and detected on the other side of the breast. Dark areas indicate regions with little X-ray attenuation while bright areas indicate regions with high X-ray attenuation. Hence, a mammogram taken with nothing in the field of view of the X-ray source will appear black, except that some noise may be present. Anything that comes in between the source and the detector (a breast or a lead marker, for example) will physically attenuate the X-rays which and will, in turn, show up as a brighter object in the mammography image. Hence, the breast in mammography images is brighter than the background. Clusters C1 and C2 are not merged if one of them is the background cluster.

If neither C1 nor C2 is the background, cluster merging unit 267 tests the second condition (S608), by calculating the absolute value of the difference between the mean intensities of clusters C1 and C2 and comparing the difference to a predetermined threshold. If the absolute value of the difference is less than the threshold, clusters C1 and C2 are merged (S610).

Cluster merging unit 267 next tests (S612) whether there are any other cluster pairs. Step S612 is also performed directly after step S606, when one of the clusters C1 and C2 is the background. Step S612 is performed directly after step S608 as well, when the absolute value of the difference between the mean intensities of clusters C1 and C2 is larger than the threshold. If there are other cluster pairs to test, cluster merging unit 267 selects (S616) a new cluster pair (C1,C2) and performs steps S606 and S608 again. When no more cluster pairs are left to test, cluster merging unit 267 outputs an image (S614) with merged clusters.

The criterion in step S608 uses an intensity-based threshold. The threshold is a relative threshold and not an absolute threshold, as it measures relative pixel value differences and not absolute ones. Relative pixel differences are easier to threshold because they are less constrained by assumptions. For example, relative differences between background and breast pixels conform to the fact that the breast is brighter than the background.

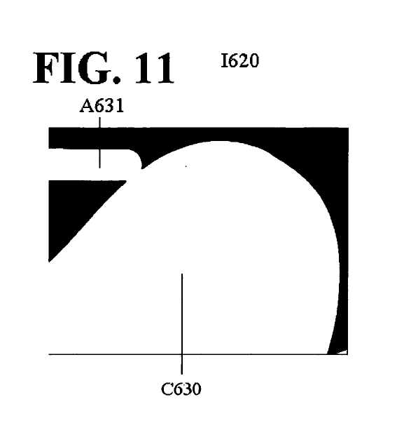

FIG. 11 illustrates an exemplary output of cluster merging unit 267 included in an image processing unit 35A for breast border detection according to an embodiment of the present invention illustrated in FIG. 10. FIG. 11 illustrates the merged cluster image I620 obtained from cluster image I589 in FIG. 9. Two clusters are present in image I620, one being the background cluster, and the other the breast cluster C630. The breast cluster incorporates the tag area A631, obtained from the breast image tag. A breast image tag is a label incorporated in the breast image that lists the view of the mammogram (Right Cranial-Caudal, Left Medial-Lateral, etc.). The tag may also list the identity of the person (patient ID) whose breasts are imaged in the mammogram.

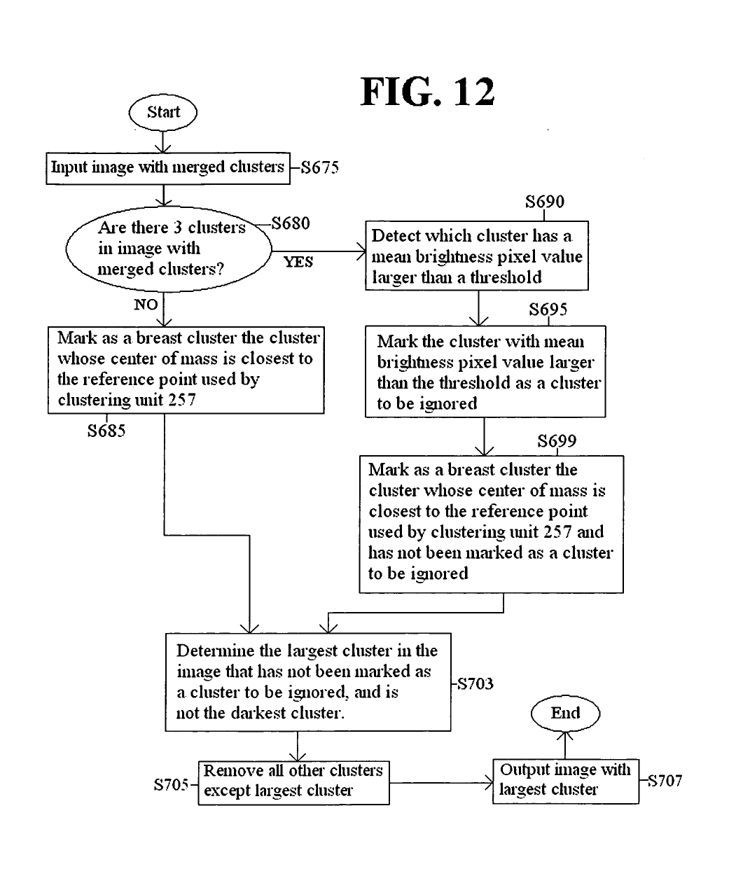

FIG. 12 is a flow diagram illustrating operations performed by a connected components analysis and selection unit 277 included in an image processing unit 35A for breast border detection according to an embodiment of the present invention illustrated in FIG. 3. The mammogram tag indicating the view of the mammogram and the patient ID may get propagated into a cluster in the merged cluster image produced by cluster merging unit 267. Connected components analysis and selection unit 277 attempts to remove the tag from the breast image.

Connected components analysis and selection unit 277 receives (S675) the image with merged clusters from cluster merging unit 267. Connected components analysis and selection unit 277 then performs a preliminary breast cluster selection.

In a breast image that does not contain implants or pacemakers, the breast cluster is usually the cluster whose center of mass is closest to the reference point used in FIG. 8. This reference point is the reference point used in FIG. 8 by clustering unit 257 to generate the 4th dimension in the 4-dimensional [symbol] ⁴ space.

In a breast image that contains implants or pacemakers, the cluster representing the implant or pacemaker is usually very bright compared to the other clusters in the breast image. This is so because implants and pacemakers, as man-made objects, tend to attenuate X-rays much more than regular human tissue. Hence, pacemakers or implants appear extremely bright in breast images. Such extremely bright clusters are called saturated clusters in the current application. Their brightness is typically in the very upper range of the pixel brightness values allowed in mammography images. In one implementation, the pixels of saturated clusters such as implants and pacemakers clusters were characterized as having a mean brightness pixel value within, for example, 80% of the maximum allowable brightness pixel value in breast images. As an example, in one implementation where the pixels brightness values in a breast image can range from 0-1023, which is usually the case for breast images, saturated clusters have a mean pixel brightness value of 818 or greater.

To perform a preliminary breast cluster selection, connected components analysis and selection unit 277 checks (S680) if the merged cluster image contains 2 or 3 clusters. If there are only 2 clusters in the merged cluster image, then connected components analysis and selection unit 277 marks as breast cluster (S685) the cluster whose center of mass is closest to the reference point used in FIG. 8 by clustering unit 257 to generate the [symbol] ⁴ space.

If there are 3 clusters in the merged cluster image, a third cluster is due to an object such as an implant or pacemaker. Connected components analysis and selection unit 277 then checks the 3 clusters for saturation, by testing (S690) which cluster has a mean brightness pixel value larger than a threshold. The threshold is a predetermined percent of the maximum allowable brightness pixel value in the breast image. After finding the cluster with a very high brightness, connected components analysis and selection unit 277 marks (S695) that saturated cluster as a cluster to be ignored, as it is not the breast cluster. Ignoring the saturated cluster, connected components analysis and selection unit 277 then marks as a breast cluster (S699) the cluster whose center of mass is closest to the reference point used in FIG. 8 by clustering unit 257 to generate the [symbol] ⁴ space.

Connected components analysis and selection unit 277 then determines (S703) the largest cluster in the merged cluster image. The largest cluster is selected from among clusters including the cluster marked as a breast cluster, but not including clusters that (a) have been marked as clusters to be ignored, or (b) are the darkest cluster. The darkest cluster is the background. Connected components analysis and selection unit 277 then removes (S705) all but the largest component (cluster) from the merged clusters image.

An image of the largest cluster is output (S707). If the tag is, for example, an isolated cluster in the merged cluster image, the largest cluster between a breast cluster and an isolated tag cluster is usually the breast cluster. Hence, connected components analysis and selection unit 277 can remove a tag using the above steps.

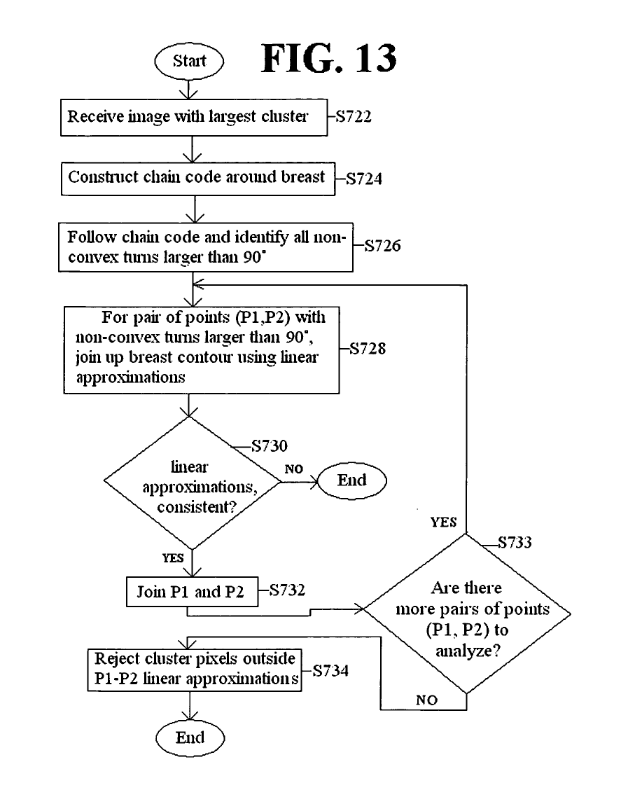

FIG. 13 is a flow diagram illustrating operations performed by a tag rejection unit 287 included in an image processing unit 35A for breast border detection according to an embodiment of the present invention illustrated in FIG. 3. The tag rejection unit 287 is used because there are cases when the tag is not removed by connected components analysis and selection unit 277. Such is the case, for example, for exemplary image I620 in FIG. 11, where the tag is solidly connected to the breast cluster and does not form a separate cluster. Tag rejection includes identifying pixels that belong to the tag, and separating, removing, or deleting those pixels from the breast image.

Tag rejection unit 287 performs an algorithm that rejects tag pixels by using shape information to remove the tag. Tag rejection unit 287 receives (S722) an image of the largest cluster from connected components analysis and selection unit 277. Tag rejection unit 287 next constructs a chain code (S724) around the breast cluster, starting from the lower left hand corner and proceeding clockwise around the breast. The chain code is a set of directional codes, with one code following another code like links in a chain. The directional code representing any particular section of the chain code is relative to, and thus dependent upon, the directional code of the preceding line segment around the breast. Hence, the obtained chain code follows a succession of pixels around the breast.

Tag rejection unit 287 follows the chain code and identifies (S726) all pixels in the chain code where the contour of the breast takes a non-convex turn greater than 90 degrees. Turning angles are calculated to identify the non-convex turns. Turning angles for a pixel M are calculated using 17 consecutive pixels along the chain code, where the 9^{th} pixel is the pixel M, 8 pixels are on one side of the 9^{th} pixel, and 8 pixels are on the other side of the 9^{th} pixel. One line is fit to the 8 pixels on one side of the 9^{th} pixel using a least squares method, and another line is fit to the 8 pixels on the other side of the 9^{th} pixel using a least squares method. The angle between these two fit lines is then calculated, to determine the turning angle associated with the 9^{th} pixel. Turning angles are calculated for each pixel along the chain code.

For each pair of pixels (P1, P2) exhibiting non-convex turns greater than 90 degrees, tag rejection unit 287 joins up (S728) the breast contour using linear approximations. Tag rejection unit 287 then tests (S730) whether the linear approximations are consistent. To determine consistency of the linear approximations for two points P1 and P2 in the chain code that exhibit non-convex turns, it is observed what happens when the chain points between the points P1 and P2 are ignored. For this purpose, two lines are fit to two sets of 20 chain points located on either side of the gap obtained by ignoring the chain points between P1 and P2. Consistency is defined using the distance between the midpoint of the line connecting the gap points, and the intersection point of the two line approximations obtained from the two sets of 20 points. A threshold based on physical distance is defined in order to establish consistency. The pairs of points P1 and P2 for which the linear approximations are consistent with one another are joined (S732).

Tag rejection unit 287 rejects (e.g. separates, or otherwise deletes) (S734) the cluster pixels left outside the linear approximation pixels, as such outside pixels belonging to a tag. To perform this rejection analysis, once it is decided which gaps are consistent and hence likely to contain tags, the gaps are joined with a line, defined by the two gap points. Since a chain code around the breast is closed, it can be traversed in a given direction, so that notions of“inside” and“outside” can be defined for the chain code. For example, by following a chain code around an object in a counter-clockwise manner, pixels to the left of the chain in the tracking direction may be termed“inside” pixels, and pixels to the right may be termed“outside” pixels. Hence, the chain code is reworked by filling in the consistent gaps with straight lines. The length of the breast is then traversed in counter-clockwise direction, removing all pixels to the right of the current segment from the breast cluster (but not from the image itself). Tag rejection unit 287 performs this analysis for all pairs of points (P1, P2) exhibiting non-convex turns greater than 90 degrees. Finally, a no-tag image is output.

In one exemplary implementation, in more than 99% of cases tags were removed from mammography images by the connected components analysis described in FIG. 12. In the rest of the cases, tags were removed from mammography images by the tag rejection unit 287 whose operation is described in FIG. 13.

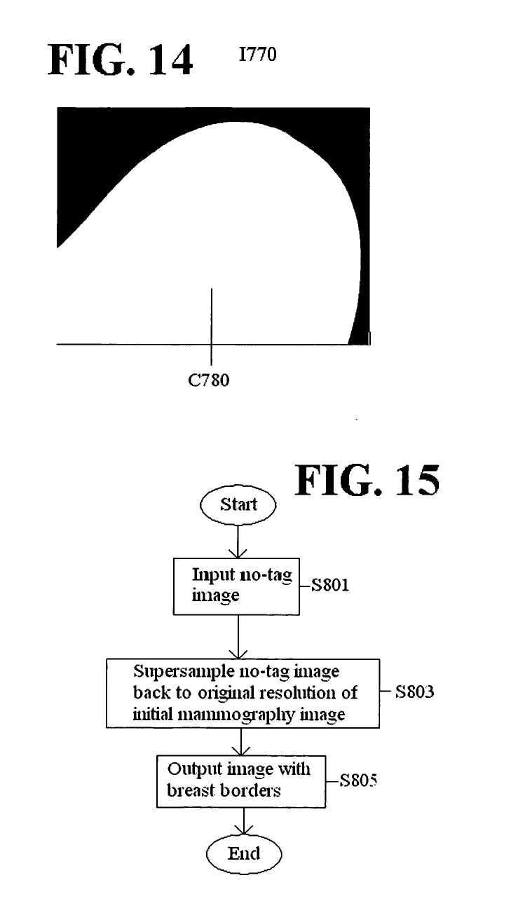

FIG. 14 illustrates an exemplary output of tag rejection unit 287 included in an image processing unit 35A for breast border detection according to an embodiment of the present invention illustrated in FIG. 13. FIG. 14 illustrates the breast image 1770 obtained from cluster image I620 in FIG. 11, with the tag area removed so that only the breast cluster C780 is left.

FIG. 15 is a flow diagram illustrating operations performed by a supersampling unit 297 included in an image processing unit 35A for breast border detection according to an embodiment of the present invention illustrated in FIG. 3. Supersampling unit 297 inputs (S801) a breast cluster image without tags, and supersamples (S803) the image back to the original resolution of the initial mammography image. Supersampling can be performed by interpolating the breast cluster image without tags to the original resolution. Supersampling can also be performed by creating a mask. The mask is a binary image the same size/resolution as the input mammogram. The mask assigns a value of 1 for every pixel that represents a breast pixel in the original image, and a value of 0 to all other pixels. The mask is supersampled to the size/resolution as the original mammogram. The mask is then applied to the original mammography image. An image showing the breast borders is output (S805). Supersampling is an optional step for the embodiments for breast border detection described in this application.

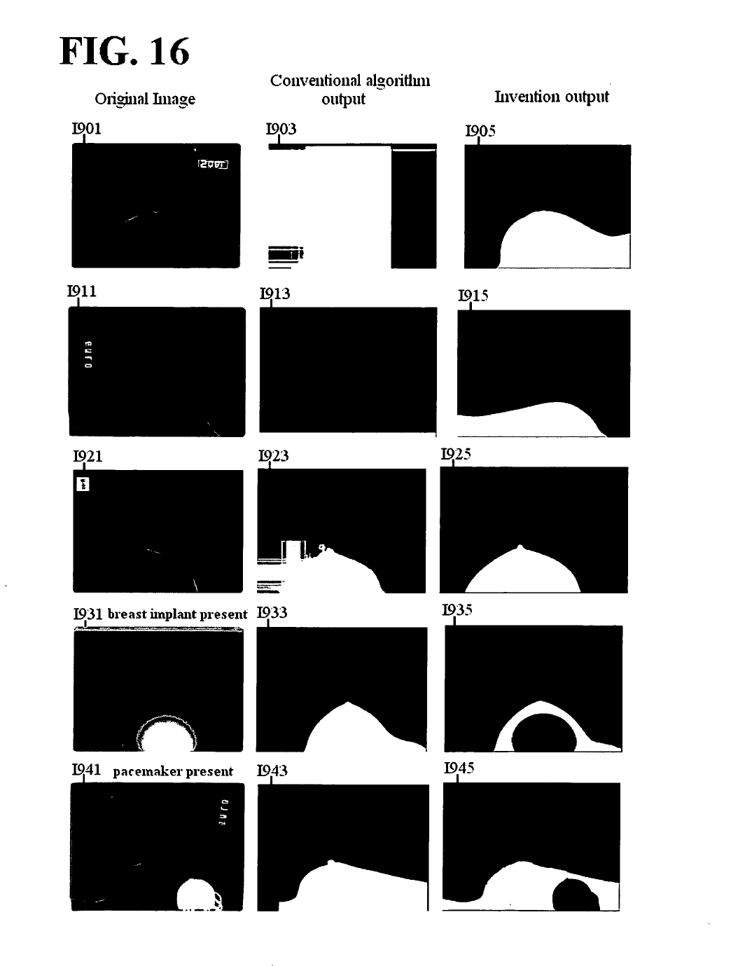

FIG. 16 illustrates exemplary outputs of an image processing unit 35A for breast border detection according to an embodiment of the present invention illustrated in FIG. 3. In FIG. 16, images located in the first column are original mammography images. Mammography image I931 shows a breast with implants, and image I941 shows a breast with a pacemaker located in the chest. Images I901, I911, I921 show breasts without implant or pacemakers. The second column shows images output by a conventional algorithm typically used for breast border detection. The third column of images shows breast border images obtained from image processing unit 35A described in the current application. As it can be seen from FIG. 16, the conventional algorithm fails to extract breast borders or shapes from the original image I901 in image I903. Image I905 obtained from image processing unit 35A correctly extracts the breast borders. Conventional algorithm image I913 corresponding to original image I911 fails to extract breast borders. Image I915 obtained from image processing unit 35A correctly extracts the breast borders. Conventional algorithm image I923 corresponding to original image I921 fails again to extract breast borders. Image 1925 obtained from image processing unit 35A correctly extracts the breast borders. Conventional algorithm image I933 corresponding to original image I931 extracts breast borders, but does not detect the presence of breast implants in the original image. Image 1935 obtained from image processing unit 35A correctly extracts the breast borders, as well as the location and shape of the breast implant. Conventional algorithm image I943 corresponding to original image I941 extracts breast borders, but does not detect the presence of the pacemaker present in the original image. Image I945 obtained from image processing unit 35A correctly extracts the breast borders, as well as the location and shape of the pacemaker.

The breast border detection technique using k-means clustering presented in the current application was tested against a database of 15,980 mammograms, using visual inspection for validation. The breast border detection technique using k-means clustering successfully extracted breast borders 99.99% of the time. The performance index for a conventional algorithm used in breast detection was 93.7%. Thus, the advantages of the present invention are readily apparent.

Although detailed embodiments and implementations of the present invention have been described above, it should be apparent that various modifications are possible without departing from the spirit and scope of the present invention.

1. An image processing method, said method comprising:
accessing digital image data representing an image including a breast;
clustering pixels of said image to obtain initial clusters, based on a parameter relating to a spatial characteristic of said pixels in said image, a parameter relating to an intensity characteristic of said pixels in said image, and a parameter relating to a smoothness characteristic of said pixels in said image; and
detecting a breast cluster, said step of detecting a breast cluster including
performing cluster merging for said initial clusters using an intensity measure of said initial clusters to obtain final clusters, and
eliminating from said final clusters pixels that do not belong to said breast, to obtain a breast cluster.

2. The image processing method as recited in claim 1, further comprising:
identifying breast borders along borders of said breast cluster.

3. The image processing method as recited in claim 1, wherein said step of clustering pixels of said image to obtain initial clusters is performed using k-means clustering.

4. The image processing method as recited in claim 3, wherein said step of k-means clustering includes:
representing said pixels of said image in a 4-dimensional space using two parameters relating to spatial characteristics of said pixels in said image, said parameter relating to an intensity characteristic of said pixels, and said parameter relating to a smoothness characteristic of said pixels in said image, wherein said parameter relating to a smoothness characteristic of said pixels in said image is based on a distance to a reference point; and
performing k-means clustering for said pixels of said image in said 4-dimensional space.

5. The image processing method as recited in claim 4, wherein said step of k-means clustering uses k=3 to obtain 3 said initial clusters.

6. The image processing method as recited in claim 3, wherein said step of k-means clustering includes:
representing said pixels of said image in a 5-dimensional space using two parameters relating to spatial characteristics of said pixels in said image, said parameter relating to an intensity characteristic of said pixels, a parameter relating to a histogram-equalized intensity characteristic of said pixels in said image, and said parameter relating to a smoothness characteristic of said pixels in said image, wherein said parameter relating to a smoothness characteristic of said pixels in said image is based on a distance to a reference point; and
performing k-means clustering for said pixels of said image in said 5-dimensional space.

7. The image processing method as recited in claim 1, wherein said intensity measure of said initial clusters is a relative intensity measure of said initial clusters with respect to one another.

8. The image processing method as recited in claim 1, wherein said sub-step of performing cluster merging for said initial clusters includes merging two clusters when said two clusters do not have the lowest mean intensity value among said initial clusters, and a difference between mean cluster intensities of said two clusters is less than a predetermined threshold.

9. The image processing method as recited in claim 8, wherein said predetermined threshold is a relative threshold.

10. The image processing method as recited in claim 1, further comprising:
cropping imaging plate pixels before said step of clustering pixels of said image to obtain initial clusters, said imaging plate pixels being identified using a sum of pixel gradients calculated along lines perpendicular to outer edges of said image.

11. The image processing method as recited in claim 1, wherein said sub-step of eliminating includes
performing a connected components analysis on said final clusters to identify potential breast clusters among said final clusters, and
retaining the largest cluster component from among said potential breast clusters.

12. The image processing method as recited in claim 11, wherein said sub-step of eliminating includes performing tag rejection by
constructing a chain code around said largest cluster component obtained from said connected components analysis,
identifying turning pixels along said chain code which perform a non-convex turn greater than 90 degrees,
joining up said turning pixels using linear approximations to identify tag pixels, and
rejecting said tag pixels from said image.

13. The image processing method as recited in claim 1, further comprising:
subsampling said image to a smaller size before said step of clustering said pixels of said image.

14. The image processing method as recited in claim 1, further comprising:
supersampling an image including said breast cluster to resolution of said image including said breast.

15. An image processing apparatus, said apparatus comprising:
an image data input unit for accessing digital image data representing an image including a breast;
a clustering unit for clustering pixels of said image to obtain initial clusters, said clustering unit clustering pixels based on a parameter relating to a spatial characteristic of said pixels in said image, a parameter relating to an intensity characteristic of said pixels in said image, and a parameter relating to a smoothness characteristic of said pixels in said image;
a cluster merging unit for performing cluster merging for said initial clusters using an intensity measure of said initial clusters to obtain final clusters; and
a border detection unit for detecting a breast cluster by eliminating from said final clusters pixels that do not belong to said breast, to obtain a breast cluster.

16. The apparatus according to claim 15, wherein said border detection unit identifies breast borders along borders of said breast cluster.

17. The apparatus according to claim 15, wherein said clustering unit clusters pixels of said image using k-means clustering.

18. The apparatus according to claim 17, wherein said clustering unit clusters pixels of said image by
representing said pixels of said image in a 4-dimensional space using two parameters relating to spatial characteristics of said pixels in said image, said parameter relating to an intensity characteristic of said pixels, and said parameter relating to a smoothness characteristic of said pixels in said image, wherein said parameter relating to a smoothness characteristic of said pixels in said image is based on a distance to a reference point, and
performing k-means clustering for said pixels of said image in said 4-dimensional space.

19. The apparatus according to claim 18, wherein said clustering unit performs k-means clustering using k=3 to obtain 3 said initial clusters.

20. The apparatus according to claim 17, wherein said clustering unit clusters pixels of said image by
representing said pixels of said image in a 5-dimensional space using two parameters relating to spatial characteristics of said pixels in said image, said parameter relating to an intensity characteristic of said pixels, a parameter relating to a histogram-equalized intensity characteristic of said pixels in said image, and said parameter relating to a smoothness characteristic of said pixels in said image, wherein said parameter relating to a smoothness characteristic of said pixels in said image is based on a distance to a reference point, and
performing k-means clustering for said pixels of said image in said 5-dimensional space.

21. The apparatus according to claim 15, wherein said intensity measure of said initial clusters is a relative intensity measure of said initial clusters with respect to one another.

22. The apparatus according to claim 15, wherein said cluster merging unit performs cluster merging for said initial clusters by
merging two clusters when said two clusters do not have the lowest mean intensity value among said initial clusters, and a difference between mean cluster intensities of said two clusters is less than a predetermined threshold.

23. The apparatus according to claim 22, wherein said predetermined threshold is a relative threshold.

24. The apparatus according to claim 15, further comprising:
a cropping unit for cropping imaging plate pixels before said clustering unit receives said image, said cropping unit identifying said imaging plate pixels by using a sum of pixel gradients calculated along lines perpendicular to outer edges of said image.

25. The apparatus according to claim 15, wherein said border detection unit eliminates pixels that do not belong to said breast by
performing a connected components analysis on said final clusters to identify potential breast clusters among said final clusters, and
retaining the largest cluster component from among said potential breast clusters.

26. The apparatus according to claim 25, wherein said wherein said border detection unit includes a tag rejection unit for performing tag rejection by
constructing a chain code around said largest cluster component obtained from said connected components analysis performed by said border detection unit,
identifying turning pixels along said chain code which perform a non-convex turn greater then 90 degrees,
joining up said turning pixels using linear approximations to identify tag pixels, and rejecting said tag pixels from said image.

27. The apparatus according to claim 15, further comprising:
a subsampling unit for subsampling said image to a smaller size before said clustering unit receives said image.

28. The apparatus according to claim 15, further comprising:
a supersampling unit for supersampling an image including said breast cluster to resolution of said image including said breast.
